(19) United States
(12) Patent Application Publication
(10) Pub. No.: US 2025/0330451 A1
(43) Pub. Date: Oct. 23, 2025

(54) SECURE PROCESS EXECUTION AND DATA MANAGEMENT WITH SECURED STORAGE AND CODE INJECTION

(71) Applicant: CyberArk Software Ltd., Petach-Tikva (IL)

(72) Inventors: Yoav BERGMAN, Petach-Tikva (IL); Naor TEDRI, Petach-Tikva (IL)

(73) Assignee: CyberArk Software Ltd., Petach-Tikva (IL)

(21) Appl. No.: 19/254,981

(22) Filed: Jun. 30, 2025

Related U.S. Application Data
(63) Continuation-in-part of application No. 18/677,085, filed on May 29, 2024.
Application No. 18/677,085 is a continuation-in-part of application No. 18/514,199, filed on Nov. 20, 2023, now Pat. No. 12,001,567.

(51) Int. Cl. H04L 9/40

(52) U.S. Cl. CPC H04L 63/0428; H04L 63/123

(57) ABSTRACT

Systems, methods, and apparatuses are disclosed for securing the use of secondary processes using secured storage and code injection. Techniques may include identifying sensitive data including at least one secret, storing the sensitive data in a secured storage location, and invoking a secondary process in a suspended mode. Techniques may further include injecting at least one first code element into the secondary process, the at least one first code element being configured to perform at least one operation associated with the sensitive data, and resuming the secondary process, wherein the injected first code element makes the stored sensitive data available to the secondary process.

### CROSS-REFERENCE TO RELATED APPLICATIONS

This application is a continuation-in-part of, and claims the benefits of priority to, U.S. application Ser. No. 18/677,085, filed May 29, 2024, which is a continuation-in-part of, and claims the benefits of priority to, U.S. application Ser. No. 18/514,199, filed Nov. 20, 2023, now U.S. Pat. No. 12,001,567, the entirety of which is hereby incorporated by reference.

### BACKGROUND

Modern software platforms employ various identification means in the form of secrets. Secrets may include passwords, usernames, Application Programming Interface (API) keys, database credentials, symmetric or asymmetric encryption keys, hash values, identity and access management (IAM) permissions, SSH keys, tokens, certificates, biometric data, personal data and other credentials. Secrets may commonly be used for managing access permissions at both human-to-application and application-to-application levels of interaction. When used appropriately, secrets may provide users and applications with access to sensitive data, systems, and services that are otherwise secured.

Starting a process, such as a software application, may involve launching the process with a command line argument that includes a secret. Command line arguments may be visible to other administrator users on the server. In some cases, command line arguments may be written to an event log or may be sent to a security information and event management system. Where sensitive data such as secrets are used in the command line arguments, such information may be exposed to unauthorized users or malicious actors. For example, malicious actors may employ means to review a command line event log to gather or collect secrets to gain unauthorized access to an application or resource, as well as additional secrets and hosts.

Technological solutions are thus needed to protect secrets when used in command line events when launching a new process, such as an application. Such solutions should prevent malicious usage of secrets in the event that a command line event log is accessed or compromised. Such solutions should include invoking, by a main process, a secondary process in a computing environment in a suspended mode and providing one or more placeholder command line entry to the secondary process. Solutions may also include retrieving a secret by the main process, and storing an operable command line entry, which may include a secret or other information, in a memory location associated with the secondary process. Solutions may also include nullifying the one placeholder command line entry and enabling the operable command line entry and use the at least one secret.

Other problems may arise in securing secrets for certain processes offered on closed-source systems. For example, certain applications may require that certain system calls or data transfers are made to or from a local disk. As one example, a Microsoft Windows® remote desktop protocol (“RDP”) file is a plain text file that may not be digitally signed in a traditional way using public key infrastructure. Instead, a signing block may be added to the end of the file with signature and sign scope keys, where the signature block calculation is performed by RDPsign.exe, an executable provided by Microsoft. That executable may access RDP files saved on the local disk and may place signed RDP files on the disk. However, a RDP file may contain sensitive data and recording such sensitive data to a local disk poses a security risk in that the local disk may be unsecure or susceptible to access by malicious attackers. Closed source or black box applications, such as RDPsign.exe, may not allow for retrieving sensitive data from secure locations or may not be able to write files containing sensitive data to secure locations using conventional techniques.

Technological solutions are thus needed to securely send sensitive data to black box or closed source processes for example, by creating a file that does not contain the actual data and overriding certain file system calls with updated logic to receive or write sensitive data from or to a different source than the one expected by the black box or closed source process. Such solutions should include identifying, by a main process a sensitive data containing at least one secret and invoking, by the main process, a secondary process in a computing environment in a suspended mode, wherein the secondary process is configured to perform at least one operation on a file associated with the sensitive data. Solutions should further include injecting at least one code element into the secondary process that redirects the secondary process to the sensitive data, and resuming the secondary process, wherein the at least one operation is performed using the sensitive data. Solutions may also include generating a placeholder file based on the sensitive data, the placeholder file excluding the at least one secret. Solutions may also include generating a modified sensitive data based on the sensitive data.

Problems may also arise in securing secrets when launching processes, such as software applications, with command line arguments that include sensitive data. Command line arguments may be visible to other administrative users on the server, written to event logs, or sent to security information and event management systems. This exposure of sensitive data in command line arguments may allow unauthorized users or malicious actors to gain unauthorized access to applications, resources, and additional secrets. For example, malicious actors may review command line event logs to gather secrets and compromise system security.

Additional challenges may arise when processes require access to multiple files containing sensitive data. Conventional methods may expose these files on local storage, increasing the risk of unauthorized access. Furthermore, conventional methods are not capable of securely providing a list of such files to a process without revealing their contents and/or locations.

Technological solutions are thus needed to protect secrets used in command line arguments when launching processes. In addition, technological solutions are needed to securely manage and provide access to sensitive files, especially when dealing with applications or processes that expect file operations to occur on local storage. Such solutions should allow for the creation of virtual files that can be securely passed to processes, while ensuring that the actual sensitive file contents remain protected and are only accessible through secure channels. For example, such solutions should include identifying, by a main process, sensitive data including at least one secret and storing the sensitive data in a secured storage location. Solutions may further include invoking, by the main process, a secondary process in a suspended mode and injecting a first code element into the secondary process, wherein the first code element is configured to override at least one second code element configured to perform at least one operation associated with the sensitive data. Solutions may further include resuming the secondary process, wherein the injected first code element makes the stored sensitive data available to the secondary process.

### SUMMARY

The disclosed embodiments describe non-transitory computer readable media, systems, and methods for securing the use of command line entries. For example, in an embodiment, a non-transitory computer readable medium may include instructions that, when executed by at least one processor, cause the at least one processor to perform operations for securing the use of command line entries. The operations may include invoking, by a main process, a secondary process in a computing environment in a suspended mode and providing one or more placeholder command line entry to the secondary process. The operations may further include retrieving at least one secret by the main process and storing an operable command line entry in a memory location associated with the secondary process, wherein the one or more placeholder command line entry is nullified, wherein the secondary process is configured to process the operable command line entry and use the at least one secret. In an embodiment, the operations may further include resuming the secondary process.

According to a disclosed embodiment, the operable command line entry may include the at least one secret. In another embodiment, the operable command line entry may be configured to assert the secret to access a protected asset. In yet another embodiment, the one or more placeholder command line entry may have a size that is equal to or larger than a size of the operable command line entry.

According to a disclosed embodiment, the operations may further comprise resuming the secondary process.

According to a disclosed embodiment, nullifying the one or more placeholder command line entry may include deleting the one or more placeholder command line entry. In another embodiment, nullifying the one or more placeholder command line entry may include overwriting the one or more placeholder command line entry with the operable command line entry.

According to a disclosed embodiment, the secondary process may be suspended immediately upon its initial execution. In another embodiment, the secondary process may be suspended before it processes any command line entries. In yet another embodiment, the operations may further include deleting the operable command line entry from the memory location associated with the secondary process after the secret is used.

According to another disclosed embodiment, a computer-implemented method for securing the use of command line entries may include invoking, by a main process, a secondary process in a computing environment in a suspended mode and providing one or more placeholder command line entry to the secondary process. The method may further include retrieving at least one secret by the main process and storing an operable command line entry in a memory location associated with the secondary process, wherein the one or more placeholder command line entry is nullified. The secondary process may be configured to process the operable command line entry and use the at least one secret.

According to a disclosed embodiment, the memory location associated with the secondary process may be a process environment block. In another embodiment, the operable command line entry may be accessed from the process environment block by the secondary process. In another embodiment, the operable command line entry may be accessed from one or more stack arguments located in a call stack associated with a thread in the secondary process.

According to a disclosed embodiment, the operable command line entry may be located using an operating system application programming interface. In another embodiment, the operable command line entry may not be made available to an auditing tool. In yet another embodiment, the one or more placeholder command line entry may be made available to an auditing tool.

According to a disclosed embodiment, the at least one secret may be retrieved from a secure secret storage location. In another embodiment, the at least one secret may be obtained from user input prior to the execution of the secondary process. In another embodiment, the secondary process may be resumed after the operable command line entry is stored in the memory location associated with the secondary process. In yet another embodiment, the method may further include deleting the operable command line entry from the process environment block after the secret is used.

According to another disclosed embodiment, a non-transitory computer readable medium may include instructions that, when executed by at least one processor, cause the at least one processor to perform operations for securing the use of secondary processes using an interprocess communication bridge. The operations may include identifying, by a main process, a sensitive data including at least one secret and invoking, by the main process, a secondary process in a computing environment in a suspended mode, wherein the secondary process is configured to perform at least one operation on a file associated with the sensitive data. The operations may further include injecting, by the main process, at least one code element into the secondary process, the code element being configured to redirect the secondary process to the sensitive data; and resuming the secondary process, wherein the at least one operation is performed using the sensitive data.

According to a disclosed embodiment, the operations may further include generating a placeholder file based on the sensitive data, the placeholder file excluding the at least one secret. In another embodiment, operations may include generating, by the secondary process, a modified sensitive data based on the sensitive data. In another embodiment, the operations may further include making the placeholder file available to the secondary process.

According to a disclosed embodiment, injecting the at least one code element may include overwriting a read file system call of the secondary process. In yet another embodiment, injecting the at least one code element may include overwriting a write file system call of the secondary process.

According to a disclosed embodiment, redirecting the secondary process to the sensitive data may include redirecting the secondary process from a location of the placeholder file to the sensitive data. In an embodiment, the location of the placeholder file may be an unsecured location.

According to a disclosed embodiment, the operations may further include receiving, from a data holder, a request for the modified sensitive data. In another embodiment, the operations may further comprise providing the modified sensitive data to the data holder in response to the request.

In another embodiment, identifying the sensitive data including at least one secret may include accessing the sensitive data via an interprocess communication bridge. In yet another embodiment, redirecting the secondary process to the location of the sensitive data may include redirecting the secondary process via the interprocess communication bridge.

According to a disclosed embodiment, a computer-implemented method for securing the use of secondary processes using an interprocess communication bridge may include identifying, by a main process, a sensitive data including at least one secret, and invoking, by the main process, a secondary process in a computing environment in a suspended mode, wherein the secondary process is configured to perform at least one operation on a file associated with the sensitive data. The computer-implemented method may further include injecting, by the main process, at least one code element into the secondary process, the code element being configured to redirect the secondary process to the sensitive data, and resuming the secondary process, wherein the at least one operation is performed using the sensitive data.

In an embodiment, the computer-implemented method may further include generating a modified sensitive data based on the sensitive data and writing the modified sensitive data to a secure location. In another embodiment, the modified sensitive data may be in the format of a remote desktop protocol file. In another embodiment, the at least one code element may be further configured to generate an indication that the at least one code element has been injected into the secondary process, and the secondary process may be resumed based on the indication.

According to a disclosed embodiment, the file associated with the sensitive data may be a remote desktop protocol file, and the modified sensitive data may be data in the format of a signed remote desktop file. In another embodiment, the data in the format of a signed remote desktop protocol file may include a signature block. In an embodiment, the code element may be a dynamic-link library. In another embodiment, the secondary process may be suspended immediately upon its initial execution. In yet another embodiment, the secondary process may be suspended before it processes any filesystem calls.

According to another disclosed embodiment, a non-transitory computer readable medium may include instructions that, when executed by at least one processor, cause the at least one processor to perform operations for securely launching a secondary process. The operations may include identifying, by a main process, sensitive data and storing the sensitive data in a secured storage location. The operations may further include invoking, by the main process, a secondary process in a suspended mode, injecting a first code element into the secondary process, the first code element configured to override at least one second code element configured to perform at least one operation associated with the sensitive data, and resuming the secondary process, wherein the injected first code element makes the stored sensitive data available to the secondary process.

According to a disclosed embodiment, the operations may further include selecting a helper process of a plurality of helper processes based on an operating platform of the secondary process, wherein injecting the first code element into the secondary process may be performed by executing the selected helper process.

According to a disclosed embodiment, the operations may further include generating at least one dummy file based on the sensitive data, the at least one dummy file being stored in the secured storage location.

According to a disclosed embodiment, injecting the first code element may include injecting a dynamic-link library (DLL) into the secondary process.

According to a disclosed embodiment, the first code element may override a command-line retrieval API request associated with the secondary process. In another embodiment, the first code element may override a file-related API request associated with the secondary process.

According to a disclosed embodiment, invoking the secondary process in a suspended mode may include invoking the secondary process in a suspended mode without a command line.

According to a disclosed embodiment, the injected first code element may read the sensitive data from the secured storage location and, in response to receiving a first indication of successful injection of the first code element, the sensitive data read from the secured storage location may be deleted from the secured storage location. In yet another embodiment, the first code element may store the sensitive data read from the secured storage location in a memory space associated with the secondary process. In yet another embodiment, the memory space associated with the secondary process may only be accessible to the secondary process.

According to a disclosed embodiment, the sensitive data stored in the secured storage location may be encrypted.

According to another disclosed embodiment, a computer-implemented method for securely launching a secondary process may include identifying, by a main process, sensitive data, and storing the sensitive data in a secured storage location. The computer-implemented method may further include invoking, by the main process, a secondary process in a suspended mode, injecting a first code element into the secondary process, the first code element configured to override at least one second code element configured to perform at least one operation associated with the sensitive data, and resuming the secondary process, wherein the injected first code element makes the stored sensitive data available to the secondary process.

In an embodiment, the secured storage location may be protected shared memory, wherein access to the protected shared memory may be prohibited to entities that are not at least one of the main process, the secondary process, or the first code element, and the protected shared memory may be accessible from when the main process invokes the secondary process to when the secondary process resumes.

According to an embodiment, the sensitive data may include at least one secret comprising at least one of a command line argument or a file list.

According to an embodiment, the first code element may be further configured to generate an indication that the first code element has been successfully injected into the secondary process, and resuming the secondary process may be based on receiving the indication that the code element has been successfully injected.

According to an embodiment, the computer-implemented method may further include verifying an integrity of the injected first code element before resuming the secondary process. In yet another embodiment, the computer-implemented method may further include securely clearing and deallocating the secured storage location before resuming of the secondary process.

According to an embodiment, the computer-implemented method may further include intercepting, by the injected code element, an API request from the secondary process to retrieve a command line argument, and making available, in response to the intercepted API request, the sensitive data stored in the protected memory to the secondary process, wherein the sensitive data may include the command line argument.

According to an embodiment, the computer-implemented method may further include intercepting, by the injected code element, an API request from the secondary process to perform an operation on a dummy file associated with the sensitive data, making available, by the injected code element in response to the operation API request, the dummy file, and executing the operation API call using the dummy file made available by the injected code element.

According to an embodiment, the operation may include at least one of a read operation, write operation, open operation, or close operation.

Aspects of the disclosed embodiments may include tangible computer readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, explain the disclosed embodiments.

FIG. 1 is a block diagram of an exemplary system for securing the use of command line entries in accordance with disclosed embodiments.

FIG. 2 is a block diagram showing an exemplary command line security invoker in accordance with disclosed embodiments.

FIG. 3 is a process flow diagram depicting use of command line entries when launching an application according to known techniques.

FIG. 4 is a process flow diagram implementing a method for securing the use of command line entries in accordance with disclosed embodiments.

FIG. 5 is a flowchart depicting an exemplary process for securing the use of command line entries in accordance with disclosed embodiments.

FIG. 6 is a diagram depicting an exemplary process for securing the use of secondary processes using an interprocess communication bridge in accordance with disclosed embodiments.

FIG. 7 is a flowchart depicting an exemplary process for securing the use of secondary processes using an interprocess communication bridge in accordance with disclosed embodiments.

FIG. 8 is a diagram depicting an exemplary system for securing the use of secondary processes using secured storage and code injection in accordance with disclosed embodiments.

FIG. 9 is a diagram depicting an exemplary process for securing the use of secondary processes using secured storage and code injection in accordance with disclosed embodiments.

FIG. 10 is a flowchart depicting an exemplary process for securing the use of secondary processes using secured storage and code injection in accordance with disclosed embodiments.

### DETAILED DESCRIPTION

In the following detailed description, numerous specific details are set forth to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

The techniques for securing the use of command line entries described herein overcome several technological problems related to security, efficiency, and functionality in the fields of cybersecurity and software management. In particular, the disclosed embodiments provide techniques for securing secrets otherwise recorded in or accessible through event logs or other systems that record, receive, retrieve or otherwise get and may enable access to such event logs, from malicious attacks. As discussed above, malicious actors may target such event logs or systems to access secrets. Existing techniques fail to secure secrets when used in a command line interface upon process launch when command line entries are otherwise logged or recorded.

The disclosed embodiments provide technical solutions to these and other problems arising from current techniques. For example, disclosed techniques may improve security by shielding or masking the secrets from input into a command line and by preventing the secret's entry into an event log or other data recorded, thus minimizing the chances of success by a malicious actor seeking secret information. Disclosed techniques for securing the use of command line entries may further be combined with security monitoring and enforcement programs. For these, and other reasons that will be apparent to those skilled in the art, the disclosed techniques provide improved security, performance, and efficiency over existing techniques.

Aspects of the present disclosure may include a computer process. A computer process may be code that is executable and can receive arguments to enable its execution. An example of a computer process may be an application program or application, but processes are not limited to application programs and may also include tasks related to the operation of an operating system, a virtual machine, a BIOS, firmware, or any other executable. An application program may be a computer program designed to carry out a specific task, other than one relating to the operation of the computer itself. Applications may typically be used by end-users, and may include word processing documents, productivity programs for generating presentations, worksheets, databases, charts, graphs, digital paintings, electronic music and digital video, banking or financial software, or any other application software.

Aspects of the present disclosure may include secrets. A secret may include passwords, user names, Application Programming Interface (API) keys, database credentials, encryption keys, hash values, identity and access management (IAM) permissions, SSH keys, tokens, certificates, biometric data, personal data and other credentials to grant permission to an identity (e.g., user, account, application, agent, virtual instance, etc.). An application may use a secret to access a resource or target service, perform a function, validate a user, or proceed with an execution step. A secret may provide users and applications with access to sensitive data, systems, and services that are otherwise secured or restricted.

Reference will now be made in detail to the disclosed embodiments, examples of which are illustrated in the accompanying drawings.

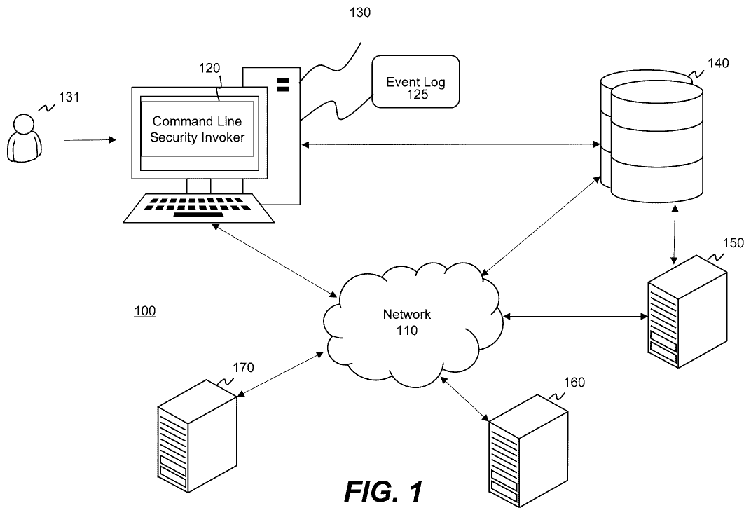

FIG. 1 illustrates an exemplary system 100 for securing the use of command line entries, consistent with the disclosed embodiments. System 100 may include one or more of a command line security invoker 120, one or more computing devices 130, one or more databases 140, and one or more servers 150, as shown in FIG. 1. System 100 may also include application server 160 and secret management server 170.

The various components may communicate over a network 110. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system 100 is shown as a network-based environment, it is understood that the disclosed systems and methods may also be used in a localized system, with one or more of the components communicating directly with each other.

Computing devices 130 may be a variety of different types of computing devices capable of developing, storing, analyzing, and/or executing software code. For example, computing device 130 may be a personal computer (e.g., a desktop or laptop), an IoT device (e.g., sensor, smart home appliance, connected vehicle, etc.), a server, a mainframe, a vehicle-based or aircraft-based computer, a virtual machine (e.g., virtualized computer, container instance, etc.), or the like. Computing device 130 may be a handheld device (e.g., a mobile phone, a tablet, or a notebook), a wearable device (e.g., a smart watch, smart jewelry, an implantable device, a fitness tracker, smart clothing, a head-mounted display, etc.), an IoT device (e.g., smart home devices, industrial devices, etc.), or various other devices capable of processing and/or receiving data.

Computing device 130 may operate using a Windows™ operating system, a terminal-based (e.g., Unix or Linux) operating system, a cloud-based operating system (e.g., through AWS™, Azure™, IBM Cloud™, etc.), or other types of non-terminal operating systems. As discussed further below, computing devices 130 may be used for executing software applications, functions, or scripts. For example, a user 131 may execute certain applications by interfacing with computer device 130.

Computer device 130 may include an event log 125. An event log may be a record of events related to the system, security, and application stored on an operating system. The event log 125 may store information about different events that occur within system 100, such as system information, application information, operation setup information, and security information. Event log 125 may include information about errors occurring within the installed software on a computing device 130. The event log 125 may contain data about security events on the system, or installation-related events. Event log 125 may log command line entries associated with the startup and use of applications running within the system 100 or the computing device 130. Example event logs may include the Windows event log, the console app on MacOS, a Linux log, or any other logging tool capable to logging command line information. An event log may export such logs of events or other information to additional systems that might store, access, retrieve, analyze or otherwise process or enable access to such data. Of course, in other embodiments, event log 125 may be located on devices other than computing device 130. For example, event log 125 may be located on server 150, application server 160, secret management server 170, another computing device, an external SIEM system, or any other computing device or server. Event log 125 may be located on the same computing device or server that contains command line security invoker 120, or the event log 125 and command line security invoker 120 may each be located on different computing devices or servers.

System 100 may further comprise one or more database(s) 140, for storing and/or executing software. For example, database 140 may be configured to store software or code, such as code or build scripts developed using computing device 130. Database 140 may further be accessed by computing device 130, server 150, or other components of system 100 for downloading, receiving, processing, editing, or running the stored software or code. Database 140 may be any suitable combination of data storage devices, which may optionally include any type or combination of subordinate databases, load balancers, dummy servers, firewalls, back-up databases, and/or any other desired database components. In some embodiments, database 140 may be employed as a cloud service, such as a Software as a Service (SaaS) system, a Platform as a Service (PaaS) system, or Infrastructure as a Service (IaaS) system. For example, database 140 may be based on infrastructure or services of Amazon Web Services™ (AWS™), Microsoft Azure™, Google Cloud Platform™, Cisco Metapod™, Joyent™, vmWare™, or other cloud computing providers. Data sharing platform 140 may also include other commercial file sharing services, such as Dropbox™, Google Docs™, or iCloud™, etc. In some embodiments, database 140 may be a remote storage location, such as a network drive or server in communication with network 110. In other embodiments database 140 may also be a local storage device, such as local memory of one or more computing devices (e.g., computing device 130) in a distributed computing environment.

System 100 may also comprise one or more server device(s) 150 in communication with network 110. Server device 150 may manage the various components in system 100. In some embodiments, server device 150 may be configured to process and manage requests between computing devices 130 and/or databases 140. In embodiments where application code is accessed within system 100, server device 150 may manage various stages of the process, for example, by managing communications between computing devices 130 and databases 140 over network 110. Server device 150 may identify application code in database 140, may receive updates when new or revised application code is entered in database 140, and may participate in securing the use of command line entries.

System 100 may also include application server 160. Application server 160 may be a server associated with a process, such as an application, running on computing device 130. In an embodiment, an application running on computing device 130 may connect to application server 160 using credentials or secrets. Application server 160 may receive data from and provide data to an application client running on computing device 130 when an application is executed.

System 100 may also include secret management server 170. Secret management server 170 may store credentials or secrets associated with an application. Secret management server 170 may be a secret vault solution where the secrets are managed, created, stored, or accessed. Secret management server 170 may communicate with computing device 130, database 140, server 150 and application server 160 to store, create, manage, and provide secrets or other credentials associated with an application or a user 131.

Command line security invoker 120 may be any device, component, program, script, or the like, for securing the use of command line entries within system 100, as described in more detail below. Command line security invoker 120 may be configured to monitor components within system 100, including computing device 130, and may communicate with database 140, server 150, application server 160, or secret management server 170. In some embodiments, command line security invoker 120 may be implemented as a separate component within system 100, capable of retrieving or generating secrets and injecting them into application instances running within network 110. In other embodiments, command line security invoker 120 may be a program or script and may be executed by another component of system 100 (e.g., integrated into computing device 130, database 140, server 150), application server 160 or secret management server 170).

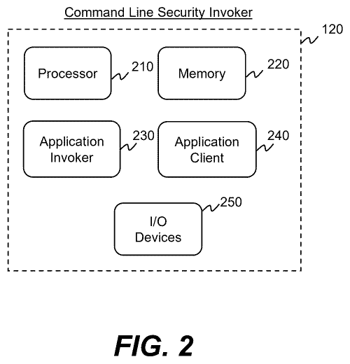

Command line security invoker 120 may comprise additional elements to facilitate analysis of software, code, functions, and/or scripts, and injection of secrets into software instance environments within system 100. FIG. 2 is a block diagram showing an exemplary command line security invoker 120 in accordance with disclosed embodiments. For example, command line security invoker 120 may be a computing device and may include one or more dedicated processors 210 and/or memories 220. Processor (or processors) 210 may include one or more data or software processing devices. For example, the processor 210 may take the form of, but is not limited to, a microprocessor, embedded processor, or the like, or may be integrated in a system on a chip (SoC). Furthermore, according to some embodiments, the processor 210 may be from the family of processors manufactured by Intel®, AMD®, Qualcomm®, Apple®, NVIDIA®, or the like. The processor 210 may also be based on the ARM architecture, a mobile processor, or a graphics processing unit, etc. In some embodiments, command line security invoker 120 may be employed as a cloud service, such as a Software as a Service (SaaS) system, a Platform as a Service (PaaS), or Infrastructure as a Service (IaaS) system. For example, command line security invoker 120 may be based on infrastructure of services of Amazon Web Services™ (AWS™), Microsoft Azure™, Google Cloud Platform™, Cisco Metapod™, Joyent™, vmWare™, or other cloud computing providers. In an embodiment, command line security invoker 120 may be integrated with a host that operates as a node in a cluster, for example, a Kubernetes™ node, and the node may further include software instance environments such as containers. In another embodiment, command line security invoker 120 may be a container deployed on a node, or it may be deployed in a layer separate from software containers. In another embodiment, command line security invoker 120 is a software application running on computing device 130.

Memory (or memories) 220 may include one or more storage devices configured to store instructions or data used by the processor 210 to perform functions related to the disclosed embodiments. Memory 220 may be configured to store software instructions, such as programs, that perform one or more operations when executed by the processor 210 to secure the use of command line entries used when initiating a software instance from computing device 130, for example, using process 500, as described in detail below. The disclosed embodiments are not limited to software programs or devices configured to perform dedicated tasks. For example, the memory 220 may store a single program, such as a user-level application, which performs the functions of the disclosed embodiments or may comprise multiple software programs. Additionally, the processor 210 may in some embodiments execute one or more programs (or portions thereof) remotely located from the computing device 130. Furthermore, the memory 220 may include one or more storage devices configured to store data (e.g., machine learning data, training data, algorithms, etc.) for use by the programs, as discussed further below.

Command line security invoker 120 may further comprise one or more components for performing various operations of the disclosed embodiments. For example, command line security invoker 120 may contain application invoker 230 and application client 240. Application invoker 230 may be configured to store, access, or run a process, such as an application, from memory, which may be memory 220. For example, application invoker 230 may be configured to access and inspect computing device 130, database 140, or server 150 for application code, launch the application in a suspended state, and may write code including secrets into a memory storage location of the application. In some embodiments, application invoker 230 may also be configured to retrieve secrets from a secret management database or server, such as secret management server 170.

Command line security invoker 120 may include application client 240. Application client 240 may be associated with the application and may receive secrets or other credentials from application invoker 230. Application client 240 may communicate with application server 160 to provide the secrets or other credentials. Application server 160 may provide information or other data desirable by the user 131 to the application client 240 when launching the application. As an example, application client 240 may be a banking application on a user's computer and application server 160 may be a banking institution. In this embodiment, application client 240 may provide login information to the banking application computer (application server 160) and may retrieve financial data pertaining to the user's account. Applications are not limited to financial software and may generally include any software applications involving an exchange of login information between a client application and a server application.

Command line security invoker 120 may include one or more input/output (I/O) devices 250. I/O devices 250 may include one or more network adaptors or communication devices and/or interfaces (e.g., Wi-Fi, Bluetooth®, RFID, NFC, RF, infrared, Ethernet, etc.) to communicate with other machines and devices, such as with other components of system 100 through network 110. For example, command line security invoker 120 may use a network adaptor to identify applications stored within system 100. In some embodiments, the I/O devices 250 may also comprise a touchscreen configured to allow a user to interact with hidden secret detector 120 and/or an associated computing device. The I/O devices 250 may comprise a keyboard, mouse, trackball, touch pad, stylus, and the like. Like processor 210 and memory 220, in embodiments where command line security invoker 120 is executed as software or code, I/O devices 250 may be associated with another component of system 100.

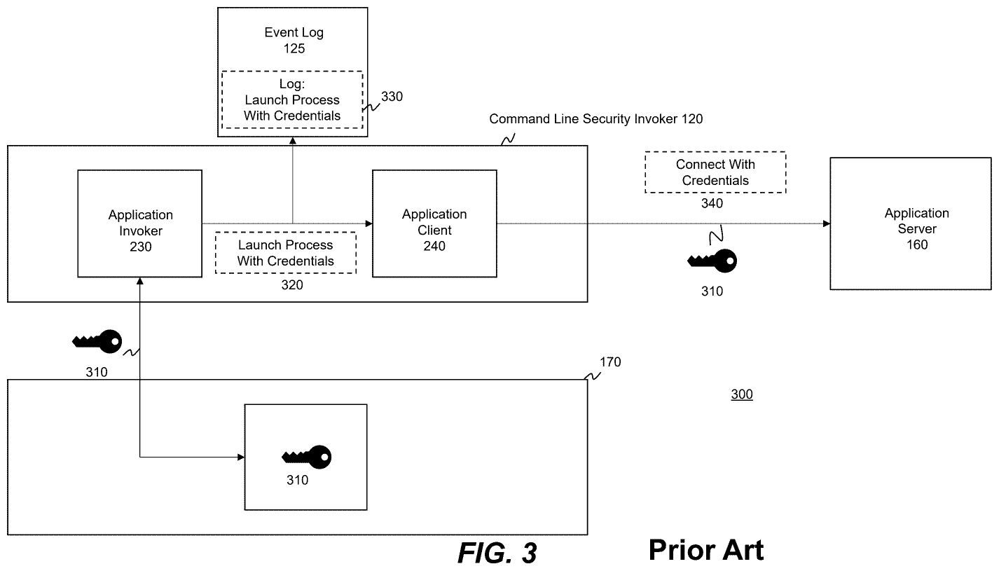

FIG. 3 is a process flow diagram 300 depicting use of command line entries when launching an application according to known techniques. During the process, application invoker 230 may launch an application. As an optional step, application invoker 230 may retrieve secret 310 from secret management server 170. Application invoker 230 may then launch the application using the secret 310 in step 320 by communicating the secret to application client 240. At step 330, and as the application is launched, event log 125 may record the event that the application is launched with secret 310, and in the process, stores the secret 310 to the event log 125. At step 340, application client 240 connects to the application server 160 using secret 310. In this conventional process, secret 310 is stored in the event log 125 and exposed to inspection or review.

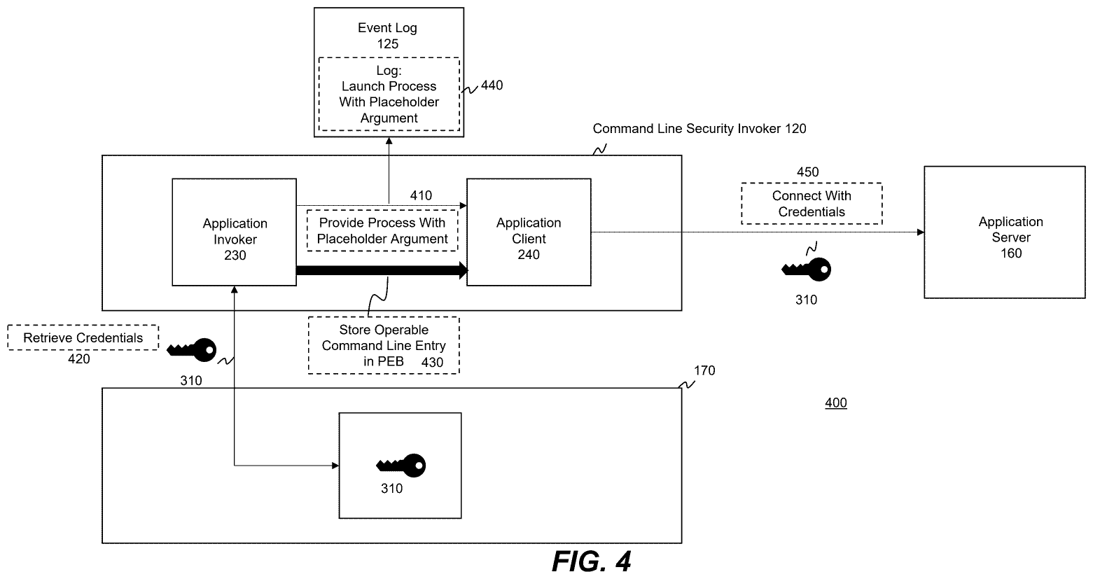

FIG. 4 is a process flow diagram implementing a process for securing the use of command line entries in accordance with disclosed embodiments. The process 400 may include invoking, by a main process, a secondary process in a computing environment. A main process may be a program or application configured to invoke a secondary process. In an embodiment, the main process may be command line security invoker 120. The main process may be configured to interact with legacy software or other applications that accept parameters in a command line argument. In some embodiments, a main process may be installed in a secure environment and may be considered trusted or secured by a user. FIG. 4 depicts an embodiment of a main process in the form of command line security invoker 120.

A secondary process may include any code or executable that accepts arguments for execution of the code. In an embodiment, the secondary process may be an application that is launched or executed by the main process, and the secondary process may be an application that requires a command line argument to launch or execute the application. The command line argument may be or include, for example, a user credential or a secret. FIG. 4 depicts an embodiment of a secondary process in the form of application client 240.

In some embodiments, the main process may invoke the secondary process in a suspended mode. Invoking in a suspended mode may generally include operations to launch the secondary process prior to registering an event in an event log. For example, invoking a secondary process in a suspended mode may include assigning memory locations, loading operating system DLLs, or allocating resources but not yet recalling specific code from the secondary process. In an embodiment, invoking the secondary process in a suspended mode may include suspending the secondary process immediately upon its initial execution. For example, the primary process may assign memory locations or load background resources and then halt processing of any more code from the secondary process application. In other embodiments, the secondary process may be suspended before it processes any command line entries.

Aspects of the present disclosure may include operable command line entries and placeholder command line entries. An operable command line entry may be a command line entry that a secondary process considers to be valid or operable to proceed with executing a function. For example, a secondary process may require an operable command line entry in the form of a valid secret to be entered into a command line to launch the secondary process or to communicate with an application server.

A placeholder command line entry may be a command line entry that is related to an argument associated with the operation of the secondary process. In an embodiment, the placeholder command line entry may be inoperable or invalid. A placeholder command line entry may be a command line entry that has a size that is equal to or larger than the memory size of the operable command line entry but is otherwise invalid. For example, if a secondary process requires an operable command line entry of a password credential of “1234,” a placeholder command line entry may be “####.” A placeholder command line entry may also be a different size than an operable command line entry, but in some embodiments, may correspond with the same argument as the operable command line entry.

In some embodiments, process 400 may include providing one or more placeholder command line entry to the secondary process. The placeholder command line entry may be provided to the secondary process when the secondary process is suspended. For example, at step 410, application invoker 230 may provide a placeholder command line entry to application client 240. In some embodiments, placeholder command line entry may be generated by application invoker 230.

In some embodiments, process 400 may include step 420 of retrieving at least one secret by the main process. A secret may be stored in a secure storage location, for example, secret management server 170. For example, application invoker 230 may contact secret management server 170 and retrieve secret 310. Secrets may also be obtained from other sources. For example, secrets may be obtained from a user through user input prior to the execution of the secondary process.

In some embodiments, process 400 may include step 430 to store an operable command line entry in a memory location associated with the secondary process. Storing an operable command line entry in a memory location associated with the secondary process may be performed by the main process, such as application invoker 230 or command line security invoker 120. In an embodiment, the operable command line entry may include at least one secret, and may, for example, include secret 310. The operable command line entry may be configured to assert the secret to access a protected asset. For example, if the secret is a user credential, the secondary process may assert the secret to overcome a challenge within its operating code, or to access an external resource. In an embodiment, application invoker 230 may store secret 310 in a memory location of application client 240 which enables application client 240 to access an external resource such as application server 160. In an embodiment, the one or more placeholder command line entry has a size that matches a size of the operable command line entry. Size may refer to memory (i.e., bits), characters, or other properties.

In an embodiment, the memory location where the operable command line entry is stored in the secondary process may be located using an operating application programming interface (API). For example, the main process may query a program function using an API, such as Windows® API to find a memory a location associated with the command line entry associated with step 410. In an embodiment, the memory location associated with the secondary process may be a process environment block (“PEB”). The PEB may be a data structure whose fields are typically used by the operating system.

In another embodiment, the secondary process may access the operable command line through one or more stack arguments located in a call stack associated with a thread in the secondary process, including but not limited to the main thread of the secondary process, or another stack data structure. A thread may be a sequence of programmed instructions and may be associated with the secondary process. Stack arguments may include information about active subroutines of a process or application and may include an operable command line argument. For example, stack arguments may be copied from a PEB into the stack, or alternatively, through registers. The operable command line argument may then be accessed from the call stack using, for example, an array parameter by the secondary process. In an embodiment, the operable command line entry may be accessed by the secondary process by examining the stack of the main thread of the secondary process. In other embodiments, the operable command line argument may be accessed in any thread's stack. For example, the main thread of a secondary process may call other threads associated with the secondary process to retrieve values for the operable command line argument.

In an embodiment, the secondary process may launch with the placeholder argument entered into the command line entry in a suspended mode. The secondary process may be resumed from the suspended mode after the operable command line entry is stored in the memory location associated with the secondary process.

At step 440, event log 125 may record that the secondary process launched with the placeholder argument and not an operable command line entry. By storing the operable command line entry in a memory location associated with the secondary process, the operable command line entry may not be made available to an auditing tool or event log 125. At the same time, the placeholder command line entry may be made available to an auditing tool or event log. In this way, the secret used in launching the secondary process may be protected.

In some embodiments, the one or more placeholder command line entry may be nullified. Nullifying the one or more placeholder command line entry may include deleting the one or more placeholder command line entry. In other embodiments, nullifying the one or more placeholder command line entry may include overwriting the one or more placeholder command line entry with the operable command line entry.

In some embodiment, at step 450, the secondary process may be configured to process the operable command line entry and use the at least one secret. Processing and using the operable command line entry may include the secondary process executing a function depending on the operable command line entry. In one example, application client 240 may connect with application server 160 using secret 310. In other embodiments, the secondary process may resolve an internal argument based on the operable command line entry that allows the secondary application to execute the remainder of its code. In an embodiment, the operable command line entry may be accessed from the process environment block by the secondary process.

In some embodiments, the operations may include deleting the operable command line entry from the memory location associated with the secondary process after the secret is used. Deleting the operable command line entry may include deleting the operable command line entry from the process environment block after the secret is used.

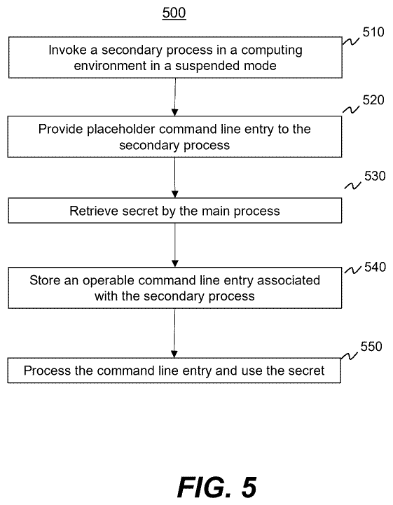

FIG. 5 is a flowchart depicting an exemplary process securing the use of command line entries in accordance with disclosed embodiments. Process 500 may be similar to process 400 described above. For example, process 500 may be performed by command line security invoker 120, application invoker 230, and application client 240, processor 210, or a combination thereof. Accordingly, any of the various functions or elements described above with respect to process 400 may equally apply to process 500, and vice versa.

Step 510 may include invoking, by a main process, a secondary process in a computing environment in a suspended mode. As described herein, a main process may be a program or application configured to invoke a secondary process. Invoking in a suspended mode may generally include operations to launch the secondary process prior to registering an event in an event log 125. For example, invoking a secondary process in a suspended mode may include assigning memory locations, loading operating system DLLs, or allocating resources but not yet recalling specific code from the secondary process. In an embodiment, invoking the secondary process in a suspended mode may include suspending the secondary process immediately upon its initial execution. For example, the primary process may assign memory locations or load background resources and then halt processing of any more code from the secondary process application. In other embodiments, the secondary process may be suspended before it processes any command line entries. A main process may be, for example, application invoker 230, and a secondary process may be application client 240.

At step 520, process 500 may include providing one or more placeholder command line entry to the secondary process. Accordingly, step 520 may substantially correspond with step 410 of process 400.

At step 530, process 500 may include retrieving at least one secret by the main process. Accordingly, step 530 may substantially correspond with step 420 of process 400.

At step 540, process 500 may include storing an operable command line entry in a memory location associated with the secondary process. Accordingly, step 540 may substantially correspond with step 430 of process 400.

At step 550, process 500 may include processing, by the secondary process, the command line entry and use of the secret. Accordingly, step 550 may substantially correspond with step 450 of process 400.

Aspects of the present disclosure include techniques for securing the use of secondary processes using an interprocess communication bridge. Inter-process communication (“IPC”) may refer to certain mechanisms provided by an operating system that allow processes to communicate with each other and synchronize their actions. For example, when multiple processes are running concurrently, they may need to exchange data or coordinate their activities. IPC provides a way for processes to interact and share information. One example method of IPC involves shared memory. In the shared memory method, processes may share a common memory region where they can read from and write to. Another method involves message passing. In message passing, processes communicate by sending messages to each other. Each process may have its own address space, and messages are explicitly sent and received. In other words, an IPC bridge allows processes to exchange data and messages.

The disclosed techniques for securing the use of secondary processes using an interprocess communication bridge overcome several technological problems related to security, efficiency, and functionality in the fields of cybersecurity and software management. In particular, the disclosed embodiments provide techniques for securing secrets or sensitive data accessible by black box or closed source processes that might otherwise read, record or require those secrets on a local disk or other unsecured location. Disclosed solutions may improve security by shielding or masking the secrets by manipulating the system calls of certain processes from an expected file location to the location of the secret, a location that may be secured. Disclosed techniques for securing the use of secondary processes using an interprocess communication bridge may further be combined with security monitoring and enforcement programs. For these, and other reasons that will be apparent to those skilled in the art, the disclosed techniques provide improved security, performance, and efficiency over existing techniques.

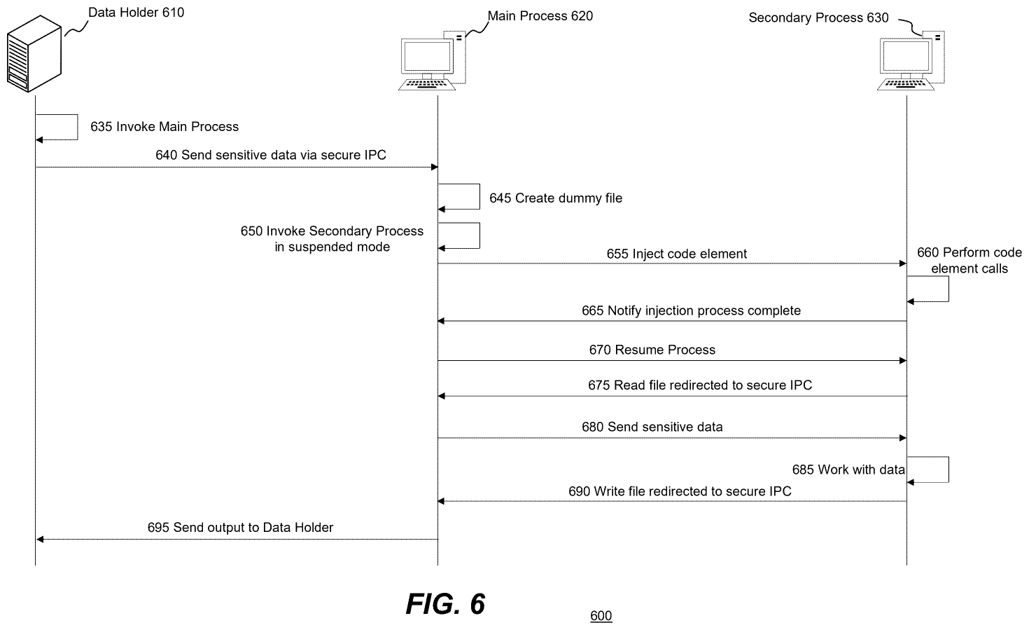

FIG. 6 is a diagram depicting an exemplary process for securing the use of secondary processes using an interprocess communication bridge in accordance with disclosed embodiments. Process 600 may include execution commands, communication calls, or other processing actions transmitted between one or more processes or programs. As one example, process 600 includes three computer processes in the form of data holder 610, main process 620, and secondary process 630. In an embodiment, data holder 610, main process 620, and secondary process 630 may each be separate computer programs operating a computing device 130. In another embodiment, data holder 610 may be a program operating on applications server 160 while main process 620 and secondary process 630 run on computing device 130. In other embodiments, each of data holder 610, main process 620, and secondary process 630 may operate on different computing devices 130, or different servers or databases, or may operate in a distributed network through a cloud-based networking system.

In an embodiment, data holder 610 may hold sensitive data such as secrets. Data holder 610 may be a known secure location for holding secrets. In another embodiment, data holder 610 may have access to and communicate with a repository of sensitive data such as secret management server 170. In another embodiment, data holder 610 may be a program that enables both end users and administrators to access and manage privileged accounts from any local or remote location through a web client. An example data holder may include CyberArk® Password Vault Web Access (PVWA) platform.

At step 635, data holder 610 may invoke a main process, such as main process 620. Invoking the main process may generally include operations to launch the main process. In an embodiment, main process 620 may be the process that oversees invoking and communication with other processes, such as secondary process 630.

In some embodiments, securing the use of secondary processes using an interprocess communication bridge may include identifying, by a main process, a sensitive data including at least one secret. In some embodiments, identifying a sensitive data may include receiving the sensitive data from another process or a thread. The other process may be operating on a different computing device or server from the main process and thus may not be operating on the local disk associated with the main process. Identifying a sensitive data may include accessing sensitive data using an API, a pipe, a socket, an environmental variable, or any other interprocess communication technique. In another embodiment, identifying a sensitive data may include receiving a path to the sensitive data.

Step 640 of process 600 illustrates one example of identifying a sensitive data including at least one secret. At step 640, data holder 610 may send sensitive data such as a secret to main process 620. In an embodiment, data holder 610 may send the sensitive data using a secure IPC. Sending the sensitive data may include transmitting the data over an API, a pipe, a socket, an environment variable, or any other interprocess communication technique.

At step 645 of process 600, main process 620 may create a dummy file, or a placeholder file. In an embodiment, creating a dummy file may include generating a placeholder file based on the sensitive data. In an embodiment, the placeholder file may exclude the at least one secret. For example, the placeholder file may be of similar file type that the secondary process is expecting to access, but sensitive data or secret that might have been contained in a sensitive file may be omitted, removed, or excluded in the placeholder file. For example, the placeholder file may contain an asterisk (“*”) instead of the actual sensitive data. In an embodiment, the replacement data used in the placeholder file may be the same character length as the sensitive data. For example, if the sensitive data is eight characters long (i.e., “PASSWORD”), the placeholder file may contain data containing eight asterisks instead of the sensitive data (i.e., “********”). Of course, placeholder characters other than asterisks may be used. In another embodiment, the placeholder file may be a blank or empty file. In some embodiments, the location of the placeholder file may be an unsecured location, for example, a local disk. As one example embodiment, a placeholder file may be a remote desktop protocol (RDP) file, though other files such as text files, csv files, presentation files, etc. may also be used.

At step 650 of process 600, main process 620 may invoke a secondary process in a suspended mode. Invoking in a suspended mode may generally include operations to launch the secondary process prior to making any system calls. For example, invoking a secondary process in a suspended mode may include assigning memory locations, loading operating system DLLs, or allocating resources but not yet recalling specific code from the secondary process. In some embodiments, securing the use of secondary processes using an interprocess communication bridge may include invoking, by the main process, a secondary process in a computing environment in a suspended mode, wherein the secondary process is configured to perform at least one operation on a file associated with the sensitive data. In an embodiment, the file associated with the sensitive data may be an RDP file or a text file. In an embodiment, invoking the secondary process in a suspended mode may include suspending the secondary process immediately upon its initial execution. For example, the primary process may assign memory locations or load background resources and then halt processing of any more code from the secondary process application. In other embodiments, the secondary process may be suspended before it processes any file system calls. The secondary process may be configured to perform at least one operation on a file associated with the sensitive data. For example, the secondary process may be configured to digitally sign the file associated with the sensitive data or it may be configured to manipulate data in the file associated with the sensitive data and write an updated file to a disk location by, for example, replacing an unsigned file with a signed file.

In some embodiments, operations may include making the placeholder file available to the secondary process. Making the placeholder file available to the secondary process may include directing the secondary process to a file location containing the placeholder file. As one example, the main process of the data holder may save the placeholder file on a disk associated with secondary process and may pass the placeholder file location to the secondary process immediately upon invoking the secondary process. When the secondary process is launched in a suspended mode, the secondary process may already have the placeholder file location as an argument.

At step 655 of process 600, main process 620 may inject one or more code element into secondary process 630. Injecting one or more code element into the secondary process 630 may include providing a code element to the secondary process 630 through the introduction of new code into the secondary process 630. For example, if the secondary process requires a certain environmental variable to run an operation, such as a file path, main process 620 may provide the code element by writing the file path to the secondary process. Aspects of securing the use of secondary processes using an interprocess communication bridge may include injecting, by the main process, at least one code element into the secondary process, the code element being configured to redirect the secondary process to the sensitive data. In an embodiment, injecting the one or more code element may include providing access to a secret based on an environmental variable, and may include at least one of a configuration file, an import file, or a request path. The code element may be configured to redirect the secondary process to the sensitive data. In one embodiment, the code element may be a dynamic-link library (DLL). In another embodiment, injecting the one or more code element may include injecting a hooking DLL into the secondary process. The hooking DLL may be configured to alter or augment the behavior of the secondary process by intercepting function calls or messages or events passed between software components. In yet another embodiment, redirecting the secondary process to the sensitive data may include redirecting the secondary process from the placeholder file to the sensitive data. In an embodiment, injecting at least one code element may include overwriting a read file system call of the secondary process. In another embodiment, injecting at least one code element may include overwriting a write file system call of the secondary process. Of course, injecting at least one code element may also include overwriting both a read file system call and a write file system call within a process, or may include other code elements.

At step 660 of process 600, secondary process may perform code element calls. Code element calls may be based on the injected code delivered to the secondary process 630 at step 655. In an illustrative embodiment where a code element in the form of a hooking DLL was provided at step 655 to the secondary process, the hooking DLL may override filesystem calls native to the secondary process 630. In this example, secondary process 630 may try to open the provided dummy file, and upon trying to read or write from this file reference, secondary process 630 may be redirected to the sensitive data sent at step 640 via a secure interprocess communication instead of the dummy file. Accordingly, while the dummy file may be stored in a local, unsecured location, the sensitive data may be accessed via the secure interprocess communication bridge. Once the injected code element logic is complete, for example, when the hooking process is complete in the hooking DLL example, the injected code logic may, at step 665, send a message to the main process 620 indicating the injected process is complete. At step 670, the secondary process may be resumed from the suspended mode. In an embodiment, the at least one code element may be configured to generate an indication that the at least one code element has been injected into the secondary process, and the secondary process may be resumed based on the indication. For example, generating an indication that the at least one code element has been injected into the secondary process may include a “done hooking message” issued to the main process when the at least one code element is a hooking DLL.

At step 675, process 600 may include the secondary process 630 reading the sensitive data due to the injected code element redirecting the location of the system calls to the secure IPC. At step 680, process 600 may include transmitting the sensitive data from the main process 620 to the secondary process 630. In an example embodiment, the secondary process 630 may retrieve the sensitive data via secure IPC under the assumption that the data came from the original filesystem location.

At step 685, secondary process 630 may work with the sensitive data provided by the secure IPC. Once the secondary process is resumed, the secondary process may perform the at least one operation using the sensitive data. For example, operations may include generating, by the secondary process, a modified sensitive data based on the sensitive data. In an embodiment, the modified sensitive data may be generated based on the result of the at least one operation performed by the secondary process using the sensitive data. In an embodiment, generating a modified sensitive data based on the result of the at least one operation may include applying a digital signature using the sensitive data. In an embodiment, the modified sensitive data may be data in the format of a signed remote desktop protocol file. In another embodiment, the data in the format of the signed remote desktop protocol file may include a signature block.

At step 690, secondary process 630 may write the modified sensitive data to the location redirected by the secure IPC. In an embodiment, instead of writing the modified sensitive data to a local disk, the modified sensitive data is redirected to the data holder 610 by way of the main process 620 acting as a bridge due to the injected code element logic.

At step 695, main process 620 may send output to the data holder 610. In an embodiment, output may include the modified sensitive data. In some embodiments, the operations may comprise receiving a request for the sensitive data from the data holder 610, or from another source. The operations may also further comprise providing the sensitive data to the data holder in response to the request.

One of skill in the art will appreciate that disclosed techniques for securing the use of secondary processes using an interprocess communication bridge improve over known security solutions used in software applications. For example, certain closed-source executables or processes may generate files containing sensitive data and may save them to an unsecure location. One example is “RDPSign.exe,” which signs RDP files and saves them to a local disk. Under the disclosed techniques, a placeholder file that does not include sensitive data may be generated by a main process. The secondary process may be launched in a suspended mode, and the main process may inject new code, such as a hooking DLL, to override the system calls called by the secondary process. The result may be that the secondary process reads the placeholder file, and as a result of the injected code, reads the sensitive data sent via secure IPC under the assumption that such data comes from the placeholder file. When performing an operation on the sensitive data, for example applying a digital signature to an RDP file, the secondary process may output modified sensitive data in the format of a signed remote desktop protocol file, and the secondary process may write the modified sensitive data to a secure location, for example, the memory of the main process, through the secure IPC instead of the local disk. In an example, the data holder may create a signed remote desktop protocol file using the modified sensitive data. Such code injection techniques may be used to secure black box processes that only support filesystem data retrieval by using secure IPC to send sensitive data to processes that are not designed to work with those IPC's. Disclosed techniques enable processes that are restricted to filesystem calls to receive data from any source instead of just the physical disk, improving security.

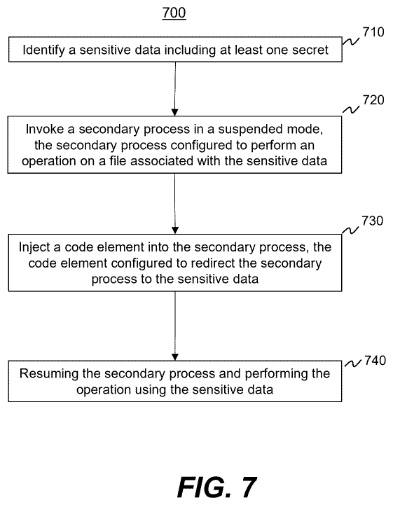

FIG. 7 is a flowchart depicting an exemplary process for securing the use of secondary processes using an interprocess communication bridge in accordance with disclosed embodiments. Process 700 may be similar to process 600 described above. For example, process 700 may be performed by data holder 610, main process 620, one or more a computing devices 130, or a combination thereof. Accordingly, any of the various functions or elements described above with respect to process 600 equally apply to process 700, and vice versa.

At step 710, process 700 may include identifying sensitive data including at least one secret. Accordingly, step 710 may substantially correspond with step 640 of process 600. At step 720, process 700 may include invoking a secondary process in a suspended mode, the secondary process configured to perform an operation on a file associated with the sensitive data. Accordingly, step 720 may substantially correspond with step 650 of process 600.

At step 730, process 700 may include injecting a code element into the secondary process, the code element configured to cause the redirection of the secondary process to the sensitive data. Accordingly, step 730 may substantially correspond with step 655 of process 600.

At step 740, process 700 may include resuming the secondary process and performing the operation using the sensitive data. Accordingly, step 740 may substantially correspond with step 670 of process 600.

Aspects of the present disclosure also include techniques for securing the use of secondary processes by storing sensitive data in secured storage and injecting code elements into the secondary processes. Secured storage may refer to storage that allows authorized processes to store, access, receive, or perform operations associated with sensitive data. For example, when a main process needs to launch a secondary process with sensitive data (e.g., command line, file list(s)), the main process may use the secured storage to store the sensitive data. The main process may then launch the secondary process in a suspended state and inject a first code element into the secondary process. After the first code element is successfully injected, the first code element may read data from the secured storage, and the data read by the first code element may then be deleted from the secured storage before the secondary process is resumed by the main process. Once the secondary process resumes, the injected code element may override system calls related to retrieving or performing operations on the sensitive data and may automatically pass the sensitive data to the secondary process. Doing so allows for the secure execution of the secondary process by accessing the sensitive data using the injected code element from secured storage rather than from potentially vulnerable or unsecured locations (e.g., local disk, system logs, history files, memory dumps, any memory or storage that could be exposed to unauthorized entities).

The disclosed techniques for securing the use of secondary processes using secured storage and injecting code elements overcome several technological problems related to security, efficiency, and functionality in the fields of cybersecurity and software management. In particular, the disclosed embodiments provide techniques for securing sensitive data or secrets accessible by processes that might otherwise perform operations on (e.g., read, record, write, or require) the sensitive data or secrets on a local disk or other unsecured location. For example, the disclosed solutions may provide techniques for securely launching and controlling processes with sensitive data (e.g., secrets, confidential parameters, credentials, tokens, passwords, encryption keys, command line arguments, file lists, biometric data), without recording the sensitive data in locations that could be exposed or vulnerable to exposure. Disclosed solutions may improve security by injecting at least one code element (e.g., DLL, hooking library, assigning memory location, function hook, code patch, API interceptor, runtime code modification, dynamic code injection, API wrapper) into the secondary process to intercept and modify the behavior of system calls associated with sensitive data such that the secondary process performs operations (e.g., read, write, open, close, etc.) on the sensitive data through the injected code element. Disclosed techniques for securing the use of secondary processes using secured storage and injecting code elements may further be combined with security monitoring and enforcement programs. For these, and other reasons that will be apparent to those skilled in the art, the disclosed techniques provide improved security, performance, and efficiency over existing techniques.

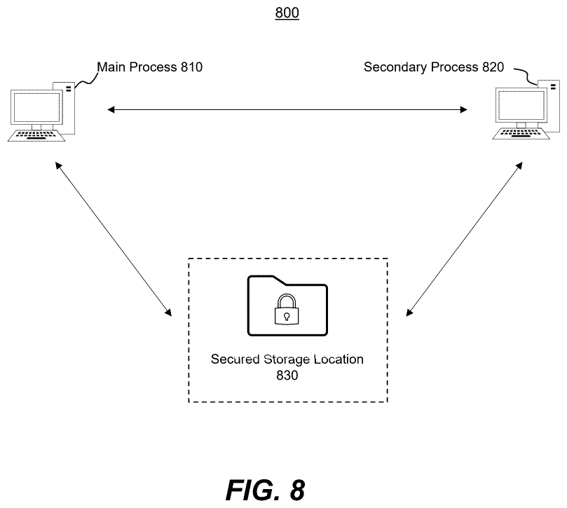

FIG. 8 illustrates an exemplary system 800 for securing the use of secondary processes using secured storage and code injection, consistent with the disclosed embodiments. System 800 may include one or more of a main process 810 (e.g., corresponding to any of the main process of FIG. 4 or main process 620 of FIG. 6), a secondary process 820 (e.g., corresponding to any of the secondary process of FIG. 4 or secondary process 630 of FIG. 6), and a secured storage location 830, as shown in FIG. 8. System 800 may also include a helper process (not pictured).

Main process 810 may be a software application configured to orchestrate (e.g., control, manage, execute) secure process execution and data management within system 800. In some embodiments, main process 810 may identify sensitive data including at least one secret. Additionally or alternatively, main process 810 may store sensitive data in secured storage location 810. Additionally or alternatively, main process 810 may invoke (e.g., initialize, activate) secondary process 820. For example, main process 810 may invoke secondary process 820 in a suspended mode. Doing so may allow main process 810 to perform controlled initialization and implement security measures before secondary process 820 resumes execution. Additionally or alternatively, main process 810 may inject a code element (e.g., executable code) into secondary process 820. For example, while secondary process 820 is in the suspended mode, main process 810 may inject a code element into the secondary process. Additionally or alternatively, main process 810 may resume secondary process 820. For example, main process 810 may resume secondary process 820 from the suspended mode in response to receiving indication of successful injection of the at least one first code element.

Secondary process 820 may be a software application, code, or any executable that accepts arguments for execution of code. In some embodiments, secondary process 820 may be invoked by main process 810. For example, secondary process 820 may be a third-party application, software, or tool invoked by main process 810. In some embodiments, secondary process 820 may be configured to perform one or more operations on data, such as sensitive data. For example, secondary process 820 may be configured to perform at least one of encryption, decryption, digital signing, or data transformation of sensitive data. In order to perform the one or more operations, secondary process 820 may require the sensitive data, which may be securely made available to secondary process 820 using secured storage location 830. For example, rather than secondary process 820 accessing an unsecure storage location (e.g., storage susceptible to unauthorized access) to retrieve sensitive data, a code element injected into secondary process 820 may read the sensitive data from secured storage location 830 and allow main process 810 to make sensitive data available to secondary process 820 in a secure manner.

Secured storage location 830 may comprise secure memory for storing sensitive data and secrets. In some embodiments, secured storage location 830 may be implemented as a protected shared memory. For example, protected shared memory may be accessible by at least one of main process 810, secondary process 820, a first code element injected into secondary process 820, at least one helper process of main process 810, as well as any other entities that main process 810 may choose to make protected shared memory accessible to.

Secured storage location 830 may include using memory protection APIs to restrict access to specific memory regions. Additionally or alternatively, secured storage location 830 may implement virtualization-based memory segmentation (e.g., page tables, creating logical separation of memory, virtual address translation, virtual machine introspection (VMI), memory ballooning to allocate and deallocate memory to processes) to create isolated memory spaces for different processes. In some embodiments, secured storage location 830 may control memory access permissions based on a process identifier (ID) associated with each process. For example, each process may be authorized to access or perform operations on a portion of secured storage location 830 corresponding to its process ID. Additionally or alternatively, secure storage location 830 may be implemented as an encrypted database. For example, secured storage location 830 may store data in an encrypted format. Secured storage location 830 may require at least one of decryption keys or authentication (e.g., multi-factor authentication, access control lists, role-based access control) to access data stored in secured storage location 830.

Secured storage location 830 may be located on or in at least one of local storage or a remote location. For example, secured storage location 830 may be located on the same computing device 130 as at least one of main process 810 or secondary process 820. In some embodiments, secured storage location 830 may be located in an operating system handling layer accessible only to main process 810 and secondary process 820. For example, secured storage location 830 may require the use of process-specific access tokens or may perform any authentication method to ensure that secured storage location 830 may only be accessed by main process 810 and secondary process 820. Additionally or alternatively, secured storage location 830 may be located on at least one computing device 130 separate from at least one of main process 810 or secondary process 820. In some embodiments, secured storage location 830 may be located in a cloud environment.

System 800 may further include at least one helper process. In some embodiments, the at least one helper process may be external to main process 810, secondary process 820, and secured storage location 830. In some embodiments, the at least one helper process may be internal to main process 810, secondary process 820, or secured storage location 830. For example, the at least one helper process may be a part of main process 810, and may select an appropriate code element for injection into secondary process 820. Selecting the appropriate code element for injection into secondary process 820 may be based on at least one of an operating platform of secondary process 820, an operating platform of main process 810, security requirements, or specific functionalities required by main process 810 or secondary process 820. For example, the main process or the at least one helper process may identify an operating platform of secondary process 820. In some embodiments, a code element injected into a secondary process operating on a 32-bit platform may be different from another code element injected into a secondary process operating on a 64-bit platform.

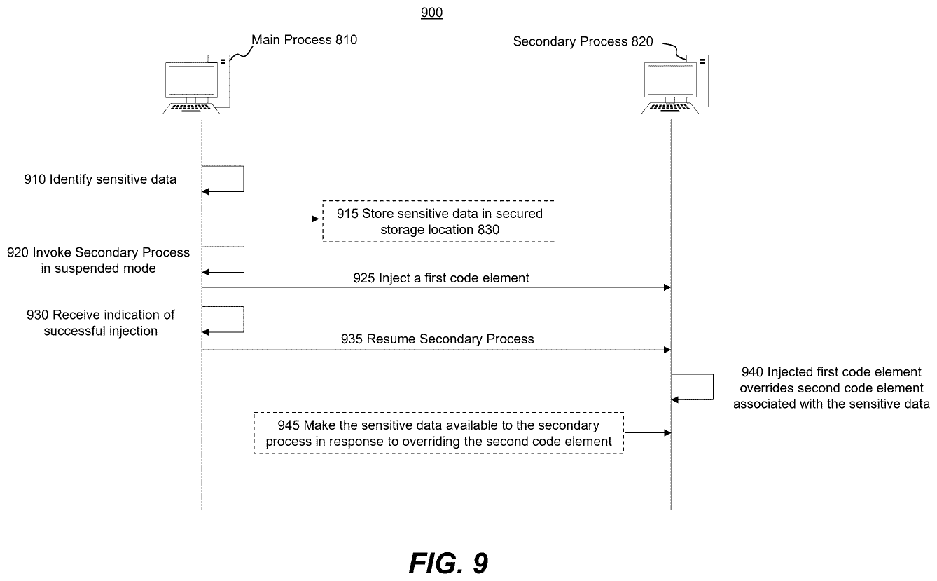

FIG. 9 is a diagram depicting an exemplary process 900 for securing the use of secondary processes using secured storage and code injection in accordance with disclosed embodiments. Process 900 may include execution commands, communication calls, or other processing actions transmitted between one or more processes or programs. As one example, process 900 includes computer processes such as a main process (e.g., main process of FIG. 4, main process 620 of FIG. 6, main process 810 of FIG. 8) and a secondary process (e.g., secondary process of FIG. 4, secondary process 630 of FIG. 6, secondary process 820 of FIG. 8). In some embodiments, the main process and the secondary process may each be separate computer programs operating a computing device (e.g., computing device 130 of FIG. 1). In some embodiments, the main process and the secondary process may operate on different computing devices, different servers or databases, or may operate in a distributed network through a cloud-based networking system. It is appreciated that the illustrated process 900 can be altered to modify the order of steps, the flow of data, and to include additional components or steps.

At step 910, the main process may identify sensitive data. In some embodiments, identifying sensitive data may include receiving the sensitive data from another process or thread (e.g., from data holder 610 of FIG. 6). For example, another process may be operating on a different computing device or server from the main process and thus may not be operating on the local disk associated with the main process. Identifying sensitive data may include accessing sensitive data using an API, a pipe, a socket, an environmental variable, or any other interprocess communication technique. In another embodiment, identifying sensitive data may include receiving a path to the sensitive data. Additionally or alternatively, identifying sensitive data may include receiving a data structure containing one or more file names and corresponding file content for each file name. Step 640 of process 600 of FIG. 6 illustrates one example of identifying sensitive data including at least one secret.

At step 915, the main process may store the identified sensitive data in a secured storage location. For example, the main process may store the identified sensitive data in secured storage location 830 of FIG. 8. In some embodiments, storing the identified sensitive data in a secured storage location may comprise storing at least one dummy file corresponding to the identified sensitive data in the secured storage location. For example, the main process may analyze the identified sensitive data to determine which files are associated with the identified sensitive data. Based on the analysis, the main process may generate at least one dummy file based on the sensitive data, and may store the at least one dummy file in the secured storage location. Sensitive data may include secrets, command line arguments, a list of files (e.g., including file names and/or file content), any suitable combination or data based on the foregoing, or any other information that may need to be protected. In some embodiments, at least one secret may be included in at least one of a command line argument or file list. For example, the main process may store command line arguments needed to launch the secondary process in the secured storage location. Additionally or alternatively, the main process may store one or more files (e.g., a list of files, file name, and/or file content) that the secondary process may perform one or more operations on in the secured storage location.

In some embodiments, the secured storage location may be accessible only within a specific session from which the secondary process is launched. For example, the system (e.g., system 800 of FIG. 8) may create the secured storage location with access control lists (ACLs) to restrict the secondary process from accessing the secured storage location outside of an authorized session. Additionally or alternatively, the system may perform session isolation to ensure that processes running in one session cannot access storage associated with processes in other sessions. Additionally or alternatively, the system may make the secured storage location accessible only within the specific session from which the secondary process is launched by using cryptography. For example, the system may generate a unique cryptographic key for each session, and may encrypt and decrypt data stored in the secured storage location using the unique cryptographic key. In some embodiments, the system may generate the unique cryptographic key for each session based on at least one of a session ID, a process launch time, or a process creation time. Additionally or alternatively, the system may make the secured storage location accessible only within the specific session from which the secondary process is launched using memory tagging. For example, the system may tag each portion of the secured storage location with a specific session ID to enforce access controls based on the tags. Additionally or alternatively, the system may make the secured storage location accessible only within the specific session from which the secondary process is launched by creating the secured storage location as a temporary object configured to be automatically destroyed when the specific session ends. Additionally or alternatively, the system may perform session bounding to bound the secondary process as only being created within the same session as the main process, which may prevent potential attackers from spawning processes in other sessions to gain access to the secured storage location. Additionally or alternatively, the secured storage location may be configured to automatically delete any data that is read by the secondary process from the secured storage location. For example, the secured storage location may be configured to automatically delete, from the secured storage location, any data that is read by a first code element injected into the secondary process. In some embodiments, the system may automatically and securely clear and/or deallocate the secured storage location or a portion thereof corresponding to the secondary process before the secondary process resumes.

At step 920, the main process may invoke the secondary process in a suspended mode. Invoking in the suspended mode may generally include operations to launch the secondary process prior to making any system calls. For example, invoking the secondary process in the suspended mode may include assigning memory locations, loading operating system DLLs, or allocating resources but not yet recalling specific code from the secondary process. In some embodiments, invoking the secondary process in the suspended mode may include suspending the secondary process immediately upon its initial execution. For example, the main process may assign memory locations or load background resources and then halt processing of any more code from the secondary process. In some embodiments, the main process may invoke the secondary process in the suspended mode before the secondary process processes any system calls. Additionally or alternatively, invoking the secondary process in the suspended mode may include invoking the secondary process without a command line. Step 650 of process 600 of FIG. 6 illustrates another example of invoking the secondary process in a suspended mode.

At step 925, the main process may inject at least one first code element into the secondary process. Injecting at least one first code element into the secondary process may include providing a first code element to the secondary process through the introduction (e.g., injection, integration) of new or complementary code into the secondary process. For example, if the secondary process requires certain sensitive information for execution, such as command line argument(s) or file(s), the main process may provide the sensitive information to the secondary process using the injected first code element. Aspects of securing the use of secondary processes using secured storage and code injection may include injecting, by the main process, at least one first code element into the secondary process, the at least one first code element being configured to pass the sensitive information to the secondary process. In some embodiments, the injected at least one first code element may be configured to read the sensitive data stored in the secured storage location and store the sensitive data read by the at least one first code element in a memory space associated with the secondary process. For example, the at least one first code element may store the sensitive data that has been read from secured storage location in an address space of the secondary process (e.g., heap memory, stack memory, encrypted memory, controlled environment of the secondary process, any other secure memory accessible to the secondary process). In some embodiments, the sensitive data stored in the memory space associated with the secondary process may only be accessible to the secondary process (e.g., utilizing protective and secure methods similar to those described with respect to secured storage location 830 of FIG. 8). In some embodiments, the at least one first code element may be a dynamic-line library (DLL). Additionally or alternatively, injecting the at least one first code element into the secondary process may include injecting a hooking DLL into the secondary process. The hooking DLL may be configured to alter or augment the behavior of the secondary process by intercepting at least one second code element (e.g., function calls, messages, or events). Step 655 of process 600 of FIG. 6 illustrates another example of injecting a code element into the secondary process.

In some embodiments, injecting the at least one first code element may include selecting at least one helper process of a plurality of helper processes configured to select at least one appropriate first code element of a plurality of first code elements for injection. For example, helper processes may be external components or may be part of the main process, and may be configured to determine which first code element(s) of the plurality of first code elements should be injected into the secondary process. In some embodiments, the main process may select at least one helper process of a plurality of helper processes based on at least one of identifying an operating platform (e.g., 32-bit, 64-bit) of the secondary process or the main process, identifying any security requirements or the secondary process or the main process, or identifying at least one type of sensitive data being handled. For example, the at least one helper process may be an operation of an operating system of the main process configured to identify an operating platform (e.g., type or version) the secondary process is running on. In some embodiments, identifying the operating platform may be based on identifying a process identifier of a process running on the operating platform. Additionally or alternatively, identifying the operating platform may be based on analyzing a version and/or platform identifier associated with each process. In some embodiments, helper processes may generate and maintain a repository of different first code elements, each first code element configured for a specific scenario (e.g., different types of DLLs, hooking libraries, inline code patches, specialized elements to handle specific types of sensitive data). For example, for a secondary process requiring access to encrypted files, helper processes may generate a first code element including decryption capabilities. In some embodiments, after selecting at least one appropriate first code element, the at least one helper process may prepare the at least one appropriate first code element for injection by customizing the at least one appropriate first code element with one or more parameters specific to a current execution context (e.g., modifying memory addresses within a code element to match a secondary process's memory layout, embedding a process ID to ensure the injected code element only operates within the intended process). Additionally or alternatively, helper processes may be configured to verify an integrity of a selected first code element before resuming the secondary process by performing an integrity check to ensure a selected first code element has not been tampered with. For example, helper processes may generate a unique identifier for each code element injection instance and log an injection process for each code element injection. In some embodiments, rather than selecting a first code element stored in the repository of different first code elements, helper processes may generate a new code element in real time as needed to accommodate a current execution environment. In some embodiments, helper processes may be configured to perform machine learning to select the at least one appropriate first code element of a plurality of first code elements for injection. For example, helper processes may be configured to perform decision tree analysis to narrow down the at least one appropriate first code element for injection.

At step 930, the main process may receive a first indication of successful injection of the at least one first code element. The first indication may be a signal, message, or return value sent from the at least one first code element or the helper process to the main process, and may confirm that the at least one first code element has been properly injected and initialized within the secondary process. In some embodiments, the first indication may include at least one of a memory address where the at least one first code element was injected or a status indicator indicating successful injection. In some embodiments, the first indication may be communicated using at least one of inter-process communication, shared memory flags, or any other communication methods to convey the first indication to the main process. In some embodiments, the main process may receive the first indication after the at least one first code element has read sensitive data from the secured storage location. Additionally or alternatively, the main process may receive the first indication before the at least one first code element has read sensitive data from the secured storage location. In some embodiments, the main process may delete the sensitive data stored in the secured storage location in response to receiving the first indication. Additionally or alternatively, the secured storage location may delete the sensitive data in response to receiving a signal from the main process.

In some embodiments, if, instead of receiving the first indication, the main process receives a second indication that injection of the at least one first code element has failed, process 800 ends and the sensitive data stored in the secured storage location is deleted. When the main process does not receive either the first indication of success or the second indication of failure within a predetermined amount of time, process 800 ends and the sensitive data stored in the secured storage location is deleted. In some embodiments, the main process may delete the sensitive data stored in the secured storage location. Additionally or alternatively, the secured storage location may delete the sensitive data in response to receiving a signal from the main process.

Step 665 of process 600 of FIG. 6 illustrates another example of receiving an indication after injecting a code element.

At step 935, the main process may resume the secondary process from the suspended mode. In some embodiments, the main process may only resume the secondary process from the suspended mode after receiving the first indication of successful injection of the at least one first code element. Additionally or alternatively, the main process may end the secondary process after receiving the second indication that injection of the at least one first code element has failed. Additionally or alternatively, the main process may end the secondary process after not receiving either the first indication or the second indication within a predetermined amount of time. In some embodiments, resuming the secondary process from the suspended mode may comprise transitioning the secondary process from the suspended mode to an active execution mode using at least one system call. When resumed from the suspended mode, the secondary process may begin execution with the injected at least one first code element in place. For example, the secondary process may be configured to execute code elements or system calls.

In step 940, the injected at least one first code element may override at least one second code element associated with the sensitive data. For example, the at least one first code element may intercept the at least one second code element to pass the sensitive data to the secondary process. The at least one second code element may be an API request, system call, file operation (e.g., open, read, write, create, close, etc.), communication function (e.g., inter-process, network), cryptographic function, authentication function, interface-related function, or any operation that may attempt to retrieve sensitive data from or perform operations on sensitive data in an unsecure location. For example, the at least one second code element may be a command-line retrieval API request associated with the secondary process. Additionally or alternatively, the at least one second code element may be a file-related API request.

In step 945, the injected at least one first code element may make the sensitive data available to the secondary process in response to overriding the second code element. For example, based on the overridden at least one second code element, the at least one first code element may make the sensitive data available (e.g., pass, cause receipt of) to the secondary process using the sensitive data retrieved from the secured storage location and stored in the memory space associated with the secondary process.

In some embodiments, the secondary process may perform (e.g., execute) at least one operation using the sensitive data (e.g., or dummy file). For example, operations may include generating, by the secondary process, a modified sensitive data based on the sensitive data. In an embodiment, the modified sensitive data may be generated based on the result of the at least one operation performed by the secondary process using the sensitive data.

In some embodiments, the secondary process may write the modified sensitive data to a secured storage location (e.g., secured storage location 830 or newly created secured storage location). For example, instead of writing the modified sensitive data to a local disk, the modified sensitive data is shared with the main process using secured storage. Additionally or alternatively, the modified sensitive data may be shared with the main process using a secure IPC. In some embodiments, the modified sensitive data may be shared with a data holder (e.g., data holder 610 of FIG. 6).

Steps 685, 690 and 695 of process 600 of FIG. 6 illustrate other examples of securing the use of secondary processes.

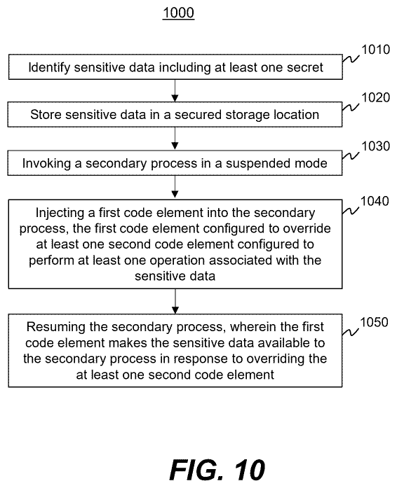

FIG. 10 is a flowchart depicting an exemplary process for securing the use of secondary processes using secured storage and code injection in accordance with disclosed embodiments. Process 1000 may be similar to process 900 described above. For example, process 1000 may be performed by a main process (e.g., main process of FIG. 4, main process 620 of FIG. 6, main process 810 of FIGS. 8 and 9), a secondary process (e.g., secondary process of FIG. 4, secondary process 630 of FIG. 6, secondary process 820 of FIGS. 8 and 9), one or more computing devices (e.g., computing device 130 of FIG. 1), or a combination thereof. Accordingly, any of the various functions or elements described above with respect to process 900 equally apply to process 1000, and vice versa. It is appreciated that the illustrated process 1000 can be altered to modify the order of steps, the flow of data, and to include additional components or steps.

At step 1010, process 1000 may include identifying sensitive data including at least one secret. Accordingly, step 1010 may substantially correspond with step 910 of process 900. At step 1020, process 1000 may include storing sensitive data in a secured storage location. Accordingly, step 1020 may substantially correspond with step 915 of process 900.

At step 1030, process 1000 may include invoking a secondary process in a suspended mode. Accordingly, step 1030 may substantially correspond with step 920 of process 900.

At step 1040, process 1000 may include injecting a code element into the secondary process, the first code element configured to override at least one second code element configured to perform at least one operation associated with the sensitive data. Accordingly, step 1040 may substantially correspond with steps 925 and 940 of process 900.

At step 1050, process 1000 may include resuming the secondary process, wherein the first code element makes the sensitive data available to the secondary process in response to overriding the at least one second code element. Accordingly, step 1050 may substantially correspond with steps 935 and 945 of process 900.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, mode-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing mode information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A non-transitory computer readable medium including instructions that, when executed by at least one processor, cause the at least one processor to perform operations for securely launching a secondary process, the operations comprising:
identifying, by a main process, sensitive data;
storing the sensitive data in a secured storage location;
invoking, by the main process, a secondary process in a suspended mode;
injecting a first code element into the secondary process, the first code element configured to override at least one second code element configured to perform at least one operation associated with the sensitive data; and
resuming the secondary process, wherein the injected first code element makes the stored sensitive data available to the secondary process.

2. The non-transitory computer readable medium of claim 1, the operations further comprising selecting a helper process of a plurality of helper processes based on an operating platform of the secondary process, wherein injecting the first code element into the secondary process is performed by executing the selected helper process.

3. The non-transitory computer readable medium of claim 1, the operations further comprising generating at least one dummy file based on the sensitive data, the at least one dummy file being stored in the secured storage location.

4. The non-transitory computer readable medium of claim 1, wherein injecting the first code element comprises injecting a dynamic-link library (DLL) into the secondary process.

5. The non-transitory computer readable medium of claim 1, wherein the first code element overrides a command-line retrieval API request associated with the secondary process.

6. The non-transitory computer readable medium of claim 1, wherein the first code element overrides a file-related API request associated with the secondary process.

7. The non-transitory computer readable medium of claim 1, wherein invoking the secondary process in a suspended mode comprises invoking the secondary process in a suspended mode without a command line.

8. The non-transitory computer readable medium of claim 1, wherein the injected first code element reads the sensitive data from the secured storage location, and wherein, in response to receiving a first indication of successful injection of the first code element, the sensitive data read from the secured storage location is deleted from the secured storage location.

9. The non-transitory computer readable medium of claim 8, wherein the first code element stores the sensitive data read from the secured storage location in a memory space associated with the secondary process.

10. The non-transitory computer readable medium of claim 9, wherein the memory space associated with the secondary process is only accessible to the secondary process.

11. The non-transitory computer readable medium of claim 1, wherein the sensitive data stored in the secured storage location is encrypted.

12. A computer-implemented method for securely launching a secondary process, the method comprising:
identifying, by a main process, sensitive data;
storing the sensitive data in a secured storage location;
invoking, by the main process, a secondary process in a suspended mode;
injecting a first code element into the secondary process, the first code element configured to override at least one second code element configured to perform at least one operation associated with the sensitive data; and
resuming the secondary process, wherein the injected first code element makes the stored sensitive data available to the secondary process.

13. The computer-implemented method of claim 12, wherein the secured storage location comprises protected shared memory, wherein access to the protected shared memory is prohibited to entities that are not at least one of the main process, the secondary process, or the first code element, and wherein the protected shared memory is accessible from when the main process invokes the secondary process to when the secondary process resumes.

14. The computer-implemented method of claim 12, wherein the sensitive data includes at least one secret.

15. The computer-implemented method of claim 14, wherein the at least one secret is included in at least one of a command line argument or a file list.

16. The computer-implemented method of claim 12, wherein the first code element is further configured to generate an indication that the first code element has been successfully injected into the secondary process, and wherein resuming the secondary process is based on receiving the indication that the code element has been successfully injected.

17. The computer-implemented method of claim 12, further comprising verifying an integrity of the injected first code element before resuming the secondary process.

18. The computer-implemented method of claim 12, further comprising securely clearing and deallocating the secured storage location before resuming of the secondary process.

19. The computer-implemented method of claim 12, further comprising:
intercepting, by the injected code element, an API request from the secondary process to retrieve a command line argument; and
making available, in response to the intercepted API request, the sensitive data stored in the protected memory to the secondary process, wherein the sensitive data includes the command line argument.

20. The computer-implemented method of claim 12, further comprising:
intercepting, by the injected code element, an API request from the secondary process to perform an operation on a dummy file associated with the sensitive data;
making available, by the injected code element in response to the operation API request, the dummy file; and
executing the operation API call using the dummy file made available by the injected code element.

21. The computer-implemented method of claim 19, wherein the operation includes at least one of a read operation, write operation, open operation, or close operation.
